(19) United States
(12) Patent Application Publication
(10) Pub. No.: US 2010/0283401 A1
(43) Pub. Date: Nov. 11, 2010

(54) System and Method for a Solid State Lighting Network Using a Power System Architecture

(76) Inventors: Chien-Hsin CHUNG, Taipei City (TW); Ming-Chang Wu, Hsinchu County (TW); Jen-Ping Tseng, Taoyuan City (TW)

Correspondence Address: Muncy, Geissler, Olds & Lowe, PLLC, 4000 Legato Road, Suite 310, FAIRFAX, VA, 22033, US

(21) Appl. No.: 12/189,169

(22) Filed: Aug. 10, 2008

(30) Foreign Application Priority Data
Mar. 12, 2008 (TW) 097108630

(51) Int. Cl. H05B 37/02

(52) U.S. Cl. 315/250

(57) ABSTRACT

A system and method for a solid state lighting network using a power system architecture, having application in a designated area to achieve energy saving control and intelligent management requirements. The present invention primarily enables implementing single or integral control of each LED light emitting device installed within a local area via a control device. The entire system is constructed using existing alternating current power lines, and the control method uses the existing power lines as channels for conveying electronic signals, and implements conversion of control signals. Moreover, alternating current carrier waves are used to complete transmission of the electronic signals, thereby achieving effective control of each LED light emitting device within a local area.

### BACKGROUND OF THE INVENTION

(a) Field of the Invention

The present invention relates to a system and method for a solid state lighting network using a power system architecture, wherein a control device is used to control each LED (light-emitting diode) light emitting device in a specific area of the structural assembly; and more particularly, the present invention relates to a system and method which uses an existing alternating current power supply system as channels for conveying electronic signals, and which implements conversion of control signals to achieve control of each LED light emitting device.

(b) Description of the Prior Art

LED (light-emitting diode) light emitting devices have considerable widespread application in current daily life and working environments, and the majority of LED light emitting devices are used for lighting purposes. Progress and development with the passing of time has seen research and application of light emitting devices being directed towards greater diversification. For example, currently, traditional light bulbs and light tubes of a portion of light emitting devices are already being gradually replaced with high power light-emitting diodes (LEDs), the primary reason being that the LED is provided with characteristics including energy saving, small size and long serviceable life. Hence, presently, having undergone substantial commercialization, there are already a great variety of light emitting devices in the market using LEDs as light sources, in particular, new buildings, designed with the primary concept to meet environmental protection demands, primarily use LED light emitting devices as the primary light sources, ambient light sources and atmosphere light sources, such as ambient light sources used in public spaces of buildings, or atmosphere light sources used in designated areas in the buildings, and so on. Referring to FIG. 1, which depicts a schematic layout of LED light emitting devices of the prior art, and as depicted in the drawing, a plurality of LED light emitting devices 11 are electrically connected to a power supply system 12, and in an actual application, such as use as ambient light sources for public areas of a multi-floor building, a plurality of the LED light emitting devices 11 are respectively disposed at appropriate positions and electrically connected to a centralized control position (which is generally a control center) via power lines, after which actuation of each of the LED light emitting devices 11 is implemented from a central control device 10 within the control center. Referring again to the drawing, in order to enable the central control device 10 to effectively control each of the LED light emitting devices 11, another network device 13 (such as a local area network layout) must be used, which is connected to each of the LED light emitting devices 11 through a sharing device 14, that is the power supply system 12 supplies the power, and the central control device 10 controls each of the LED light emitting devices 11 via the network device 13. Accordingly, when laying out the wiring and installing the LED light emitting devices 11, apart from having to complete layout and connecting of the power, moreover, technicians must also complete layout and connecting of the network wiring. However, regarding the state of current practice, technicians are generally unable to complete layout and configuration of the network portion of the installation. Hence, another group of constructors must take responsibility for the network layout in order to complete the entire installation, as a result of which installation and configuration costs are substantially increased. Furthermore, because the installation procedure evidently requires two stages in order to complete, thus, there is a higher degree of difficulty if it is required to implement installation of such a local area layout in a general household, and because specialized constructors are required to complete installation, thereby making universal application more difficult.

### SUMMARY OF THE INVENTION

In light of the aforementioned problems, in order to achieve enabling energy saving LED light emitting devices receive substantial universal application, the inventor of the present invention carried out analysis of layout methods of existing local area LED light emitting devices with the hope of developing a simpler system and control method thereof. Hence, a primary objective of the present invention is to provide a system and method which enable easy installation and effective control of LED light emitting devices disposed in a local area, thereby enabling the LED light emitting devices meeting energy saving requirements to receive widespread application.

In order to achieve the aforementioned objective, the present invention primarily uses a control device and an existing alternating current power system to complete electrical connection. Actuation of the control device outputs a function control signal, and existing power lines are used as channels for conveying and transmitting the signal to each LED light emitting device for actuation thereof to produce a corresponding action. The present invention primarily uses alternating current power lines, by means of an identical data transmission protocol transformat or transmission means such as PLC (Power Line Communication) technology, between the control device and the LED light emitting devices to achieve transmission and conversion of signals, which are effectively applied in the control system of the LED light emitting devices. Accordingly, the present invention eliminates the need to separately install network equipment while achieving central control of functionality of each of the LED light emitting device. Hence, regardless of whether implementing installation of large-scale local area LED light emitting devices or installation of household medium and small sized local area LED light emitting devices, they can be similarly completed using the simplest installation method, thereby effectively promoting the ideal of universalizing energy saving LED light emitting devices.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic layout of an LED light emitting device of the prior art.

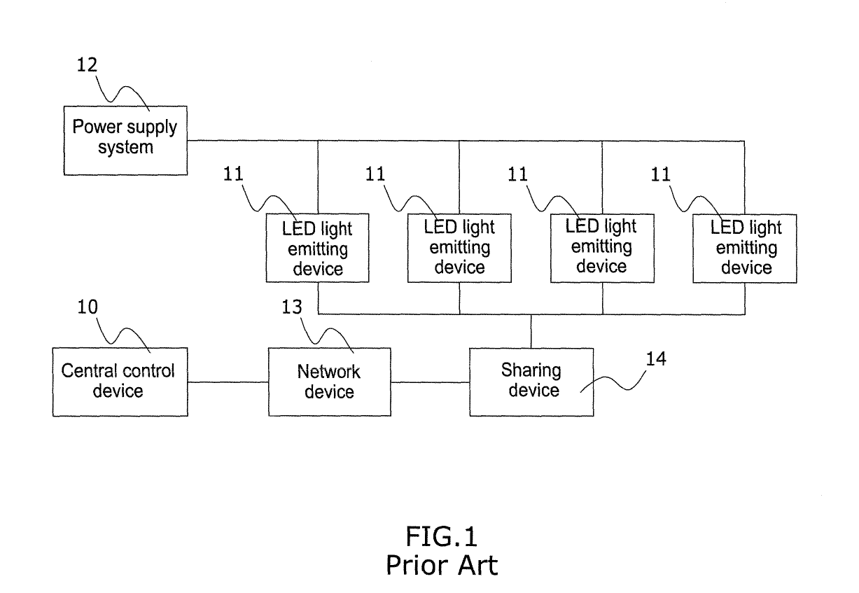

FIG. 2 is a schematic view of the system according to the present invention.

FIG. 3 is a schematic view of the method of an embodiment according to the present invention.

FIG. 4 is another preferred embodiment (1) of the present invention.

FIG. 5 is yet another preferred embodiment (2) of the present invention.

### DETAILED DESCRIPTION OF THE PREFERRED EMBODIMENTS

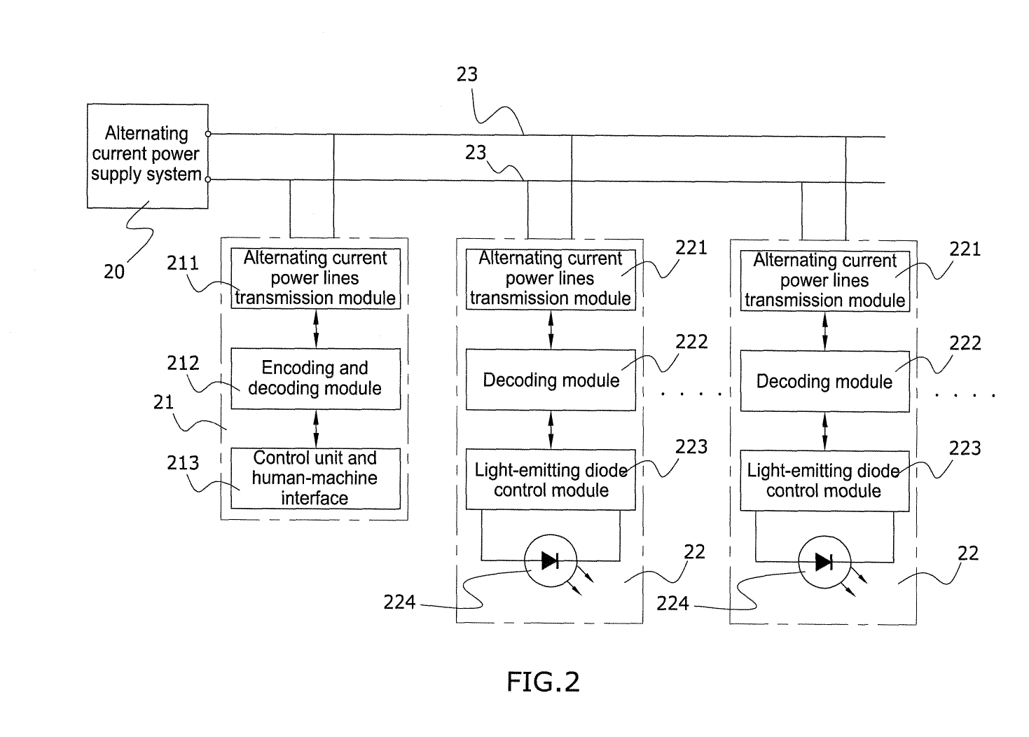

Referring to FIG. 2, which depicts a schematic view of a system of the present invention, and as depicted in the drawing, when implementing the present invention, an existing alternating current power supply system 20 is used as the primary power source supply. Moreover, existing alternating current power lines 23 are used as electrical connections between the various electronic devices and components and as channels for conveying function control electronic signals output by a control device 21. Furthermore, each LED (light-emitting diode) light emitting device 22 is electrically connected to the power lines 23, that is, apart from being used to transmit power, the LED light emitting devices 22 are also able to use the power lines 23 to receive the transmitted electronic signals. Referring again to the drawing, the control device 21 is primarily structured to comprise an alternating current power lines transmission module 211, an encoding and decoding module 212, and a control unit and human-machine interface 213, wherein the function control device 21 uses the alternating current power lines transmission module 211 to complete electrical connection to the alternating current power supply system 20. An operator is thus able to use the control unit and human-machine interface 213 to carry out relevant functions, and during operation by the operator, the control unit and human-machine interface 213 outputs a function signal, the function command of which is then encoded by the encoding and decoding module 212, whereupon the encoded signal formed after encoding is output via the alternating current power lines transmission module 211 and transmitted to each of the LED light emitting devices 22 through use of the power lines 23 as channels to convey the signal. As depicted in the drawing, each of the LED light emitting devices 22 is primarily structured to comprise an alternating current power lines transmission module 221, a decoding module 222, a light-emitting diode control module 223 and at least one light-emitting diode 224, wherein the LED light emitting devices 22 use the alternating current power lines transmission modules 221 to complete electrical connection to the alternating current power supply system 20. When the alternating current power lines transmission modules 221 of the LED light emitting devices 22 receive the encoded signal output by the control device 21, then the encoded signal is decoded using the decoding module 222 to produce a decoded signal, which is then transmitted to the light-emitting diode control modules 223, and the light-emitting diode control modules 223 actuate the light-emitting diodes 224 to produce a corresponding action according to the function command of the decoded signal, for example, to light up or switch off. Referring again to the drawing, during implementation of the present invention, one control device 21 can simultaneously control one set or a plurality of sets of LED light emitting devices 22.

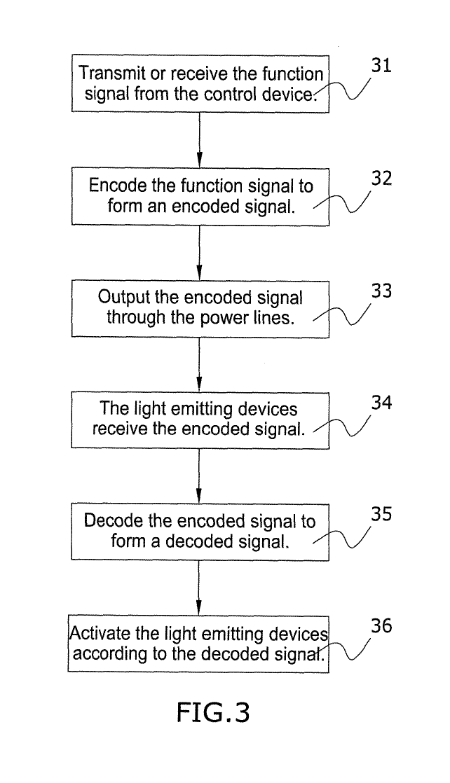

Referring to FIG. 3, which shows a schematic view depicting a control method of an embodiment according to the present invention, the method is described as follows (referring in conjunction with FIG. 2):
(1) First step (31): The control device 21 outputs a function signal from the control unit and human-machine interface 213 according to the operation by the operator, for example, the function signal is a signal to ‘switch on the light’, and means of the output function signal can, for example, be a simplified resistance modulation signal, or a frequency oscillation modulation signal, or a voltage amplitude modulation signal, or a wireless remote control frequency transmission signal, and so on;
(2) Second step (32): The encoding and decoding module 212 converts the function signal into an encoded signal which can be transmitted through the power lines 23;
(3) Third step (33): The encoded signal is output via the alternating current power lines transmission module 211 and then transmitted through the power lines 23;
(4) Fourth step (34): The LED light emitting devices 22 receive the encoded signal output via the alternating current power lines transmission modules 221;
(5) Fifth step (35): The decoding modules 222 decode the encoded signal and produce a decoded signal, which is transmitted to the light-emitting diode control modules 223;
(6) Sixth step (36): The light-emitting diode control modules 223 actuate the light-emitting diodes 224 to produce a corresponding action according to the decoded signal.

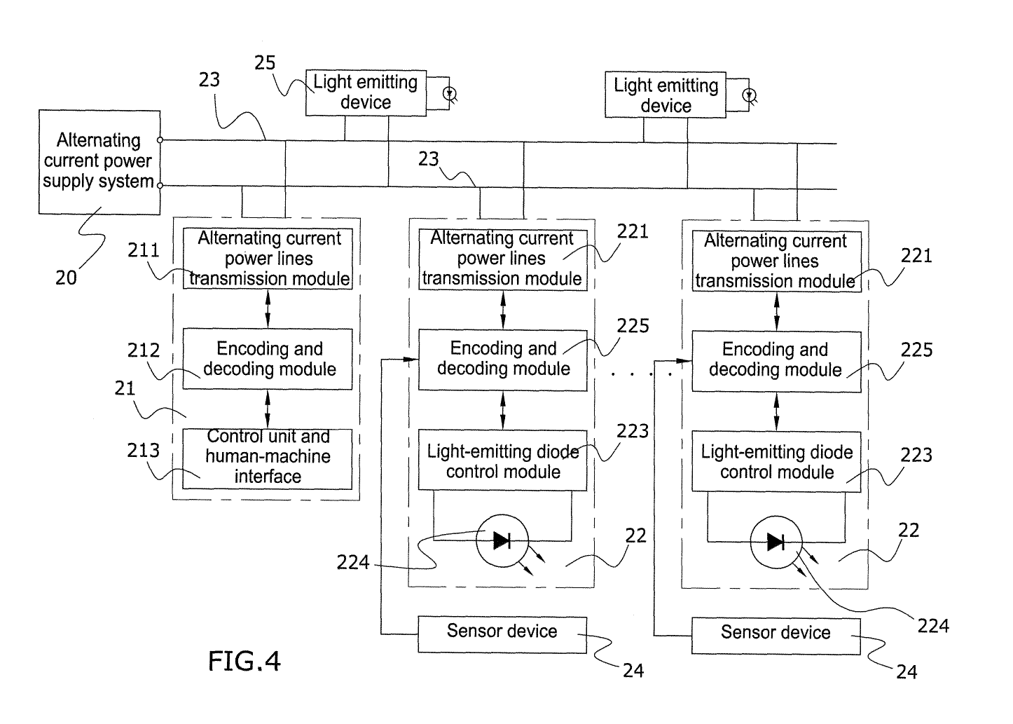

Referring to FIG. 4, which shows another preferred embodiment (1) of the present invention, and as depicted in the drawing, the present invention can also be additionally installed with sensor devices 24 to form an interactive system. As depicted in the drawing, each of the LED light emitting devices 22 are additionally installed with the sensor device 24 (or can be directly installed in the LED light emitting devices 22 using a circuit design), furthermore, the decoding modules 222 originally only having decoding functionality can be also replaced with encoding and decoding modules 225 provided with encoding functionality, and electrical connections are respectively completed between the sensor devices 24 and the respective encoding and decoding modules 225.

Accordingly, when the sensor devices 24 sense a change in the local environment, then a signal is fed back to the encoding and decoding modules 225, and, after encoding, an encoded signal is produced, which is output via the alternating current power lines transmission modules 221 and transmitted (signal feedback) through the power lines 23 to the control device 21. After decoding the encoded signal using the encoding and decoding module 212, then the decoded signal is transmitted to the control unit and human-machine interface 213, which automatically outputs a function signal to effect a corresponding action. Method of the succeeding actions is as described in each of the steps of FIG. 3. Accordingly, the overall system can be configured to allow for completely manual operation, automatic operation, or semiautomatic operation according to needs, thereby substantially extending applicability of the overall system. Referring again to the drawing, during implementation, other LED light emitting devices can be additionally installed within the applicable area of the power lines 23 infrastructure range, for example, a single light installation. As an illustration, when the sensor devices 24 are installed in a high floor and sense that the outdoor ambient brightness is lower than a set value, then a signal is fed back to the encoding and decoding modules 225, and, after encoding, an encoded signal is output and transmitted to another set of LED light emitting devices 25 installed in a low floor or an area where light is inadequate. Each of the LED light emitting devices 25 is internally provided with a decoding module or unit (not shown in the drawing) able to decode signals, and when the LED light emitting devices 25 receive the aforementioned encoded signal, then the LED light emitting devices 25 are able to implement decoding, after which the LED light emitting devices 25 can be actuated and switched on. According to the above, during implementation of the present invention, LED light emitting devices can be installed at different locations according to actual requirements and circumstances, and installation disposition of related devices, including control devices, sensors, and so on, is used to better effectively extend practicability of the present invention.

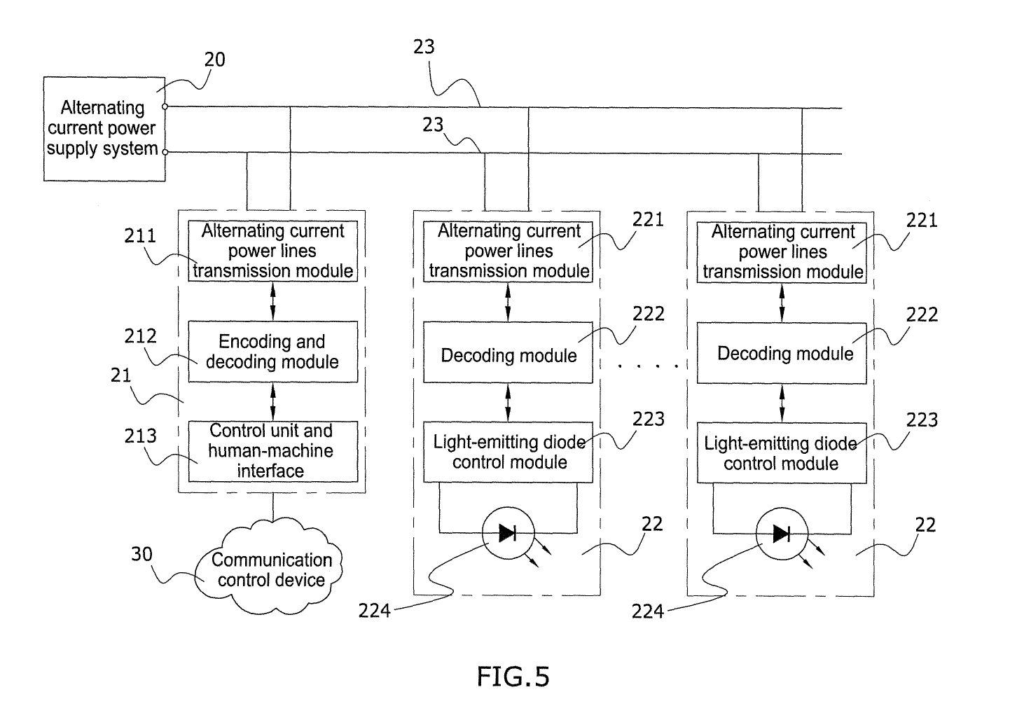

Referring to FIG. 5, which shows another preferred embodiment (2) of the present invention, and as depicted in the drawing, during implementation of the present invention, another communication control device 30 can be used to implement operation of the entire system, for example, use of a telephone, a mobile phone, a computer, a notebook computer, and the like, that is, the control device 21 in the present invention can be further configured with a plurality of information transmission interfaces to extend operational requirements of the present invention. As depicted in the drawing, the communication control device 30 primarily uses different communication interfaces to complete information connection to the control device 21, example connection means include: Ethernet transmission, a USB (Universal Serial Bus), wireless transmission, infrared wireless transmission, Internet transmission, Bluetooth, and ZigBee, and so on. When the operator is located in an environment outside the system architecture, then the communication control device 30 can be used to complete information connection to the control device 21 through the aforementioned interfaces to implement operation of the entire system. As an illustration, if the system is established in a small area of a household, then even if the owner of the household is not at home, he can use a mobile phone, a computer, and the like, to connect to the control device 21 within the household using the Internet at the remote end, thereby enabling the owner to switch on house lights via remote end control means before entering the household.

According to the above, the present invention uses the power lines 23 in an existing power installation to serve as channels for conveying signals, thereby eliminating the need for setting up a network system architecture, and, relatively speaking, general constructors are able to complete installation. Even if the present invention is installed in a general household, general technicians are able to complete installation thereof, thereby substantially reducing the inside knowledge required of the application, and thus providing a practical impetus to universalize implementation of related LED type energy saving LED light emitting devices.

Furthermore, the control method applied in the present invention uses existing power lines to serve as channels for transmitting signals, and, through circulation of alternating current, the LED light emitting devices 22 can directly receive frequency or voltage signals output by the control device 21 to produce the corresponding action, thereby eliminating the need for the layout of additional connecting lines as required in the prior art, and thus conducive to convenient installation during construction of the system. In addition, the system is provided with a plurality of transmission interfaces, and use of information connection thereto enables an unrestricted operating position, thereby substantially improving applicability of the system.

To sum up, the present invention primarily uses an existing electrical power system architecture to enable electronic signals to be directly transmitted through the power lines by an alternating current power lines carrier method, thereby eliminating the need to separately install a set of lines while achieving effective control of a plurality of LED light emitting devices. Implementation has shown that the present invention can assuredly achieve providing a method and system to enable easy installation of local area LED light emitting devices, which can be effectively controlled, thereby enabling the LED light emitting devices meeting energy saving requirements to receive widespread application. Moreover, using existing power line layout architectures enables installation of light-emitting diode light sources to be completed quickly, and after installation, the operator is able to implement effective adjustment and control of the light-emitting diode light sources.

In conclusion, the present invention complies with the essential elements as required for a patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A system and method for a solid state lighting network using a power system architecture, wherein a system comprises:
an alternating current power supply system, providing alternating current power;
a plurality of LED (light-emitting diode) light emitting device, electrically connected to the alternating current power supply system using power lines; and
a control device, electrically connected to the alternating current power supply system using the power lines, the control device is able to transmit or receive the function signal, and the power lines are used to convey the function signal to the LED light emitting devices, thereby actuating the LED light emitting devices to produce an action therein.

2. The system and method for a solid state lighting network using a power system architecture according to claim 1, wherein the control device comprises an alternating current power lines transmission module, an encoding and decoding module and a control unit and human-machine interface.

3. The system and method for a solid state lighting network using a power system architecture according to claim 1, wherein the LED light emitting device of the system comprise an alternating current power lines transmission module, a decoding module, a light-emitting diode control module and at least one light-emitting diode.

4. The system and method for a solid state lighting network using a power system architecture according to claim 3, wherein the decoding module is replaced with an encoding and decoding module.

5. The system and method for a solid state lighting network using a power system architecture according to claim 4, wherein the encoding and decoding module is electrically connected to a sensor device.

6. The system and method for a solid state lighting network using a power system architecture according to claim 1, wherein the control device in the system is installed with at least one of the following:
Ethernet transmission, or USB (Universal Serial Bus), or wireless transmission, or infrared wireless transmission, or Internet transmission, or Bluetooth, or ZigBee.

7. The system and method for a solid state lighting network using a power system architecture according to claim 1, wherein the control device Interfaces are information connected to a communication control device.

8. The system and method for a solid state lighting network using a power system architecture according to claim 2, wherein the control device Interfaces are information connected to a communication control device.

9. A system and method for a solid state lighting network using a power system architecture, wherein a control method comprises:
a first step: a control device outputs a function signal from a control unit and human-machine interface according to the operation by the operator;
a second step: an encoding and decoding module converts the function signal into an encoded signal which is able to be conveyed through power lines;
a third step: the encoded signal is output via an alternating current power lines transmission module and then transmitted through the power lines;
a fourth step: LED light emitting devices receive the encoded signal output via alternating current power lines transmission modules;
a fifth step: decoding modules decode the encoded signal and produce a decoded signal, which is transmitted to light-emitting diode control modules;
a sixth step: the light-emitting diode control modules actuate light-emitting diodes to produce a corresponding action according to the decoded signal.

10. The system and method for a solid state lighting network using a power system architecture according to claim 8, wherein, before the first step of the control method occurs, after sensor devices sense a change in the local environment, then a signal is fed back to the encoding and decoding modules, and, after encoding, an encoded signal is produced and transmitted to the control unit and human-machine interface in the first step, and after the human-machine interface automatically outputs a function signal, then the second to sixth steps are completed.
